(19) United States
(12) Patent Application Publication
(10) Pub. No.: US 2016/0014718 A1
(43) Pub. Date: Jan. 14, 2016

(54) QUICK PAGING METHOD AND APPARATUS IN LTE

(71) Applicant: SIERRA WIRELESS, INC., Richmond (CA)

(72) Inventors: Naveen MYSORE BALASUBRAMANYA, Vancouver (CA); Lutz Hans-Joachim LAMPE, Vancouver (CA); Gustav Gerald VOS, Surrey (CA)

(21) Appl. No.: 14/799,513

(22) Filed: Jul. 14, 2015

Related U.S. Application Data
(60) Provisional application No. 62/024,342, filed on Jul. 14, 2014.

(51) Int. Cl. H04W 68/02; H04W 72/04; H04W 56/00; H04W 72/00

(52) U.S. Cl. CPC H04W 68/02; H04W 72/005; H04W 72/042; H04W 56/00

(57) ABSTRACT

The present invention provides a method and system for influencing operation of a plurality of UEs in an LTE wireless network. The method comprises partitioning the plurality of UEs into a plurality of groups; determining a non-paging group including one or more of the plurality of groups which include UEs that will not be paged in an upcoming paging occasion; transmitting a message to the plurality of UEs indicative of said non-paging group; and for UEs belonging to said non-paging group, entering a sleep mode upon successful reception of the message.

### FIELD OF THE INVENTION

The present invention pertains in general to wireless communications and in particular to methods and apparatus for paging terminals in Long Term Evolution (LTE) communication systems.

### BACKGROUND

Mobile wireless devices typically have limited battery life and reducing power consumption is an ongoing concern. As radio receivers typically consume significant power, one common approach is to turn off the radio when not in use. However in cellular systems such as LTE, mobile devices are also required to be sufficiently responsive to paging messages, for example to allow mobile devices to be contacted without significant delay.

Various power saving schemes for mobile wireless devices such as pagers have been proposed, for example in U.S. Pat. No. 6,097,933. However, many legacy schemes are not completely adapted for current wireless communication systems, and alternative and/or further refined schemes would be useful to the wireless communication industry.

Therefore there is a need for methods and apparatus for paging terminals in LTE communication systems that is not subject to one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for paging terminals in LTE communication systems. In accordance with an aspect of the present invention, there is provided a method for influencing operation of a plurality of User Equipment (UE)s in an LTE wireless network, the method comprising: partitioning the plurality of UEs into a plurality of groups; determining a non-paging group, the non-paging group including one or more of the plurality of groups which include UEs that will not be paged in an upcoming paging occasion; transmitting a message to the plurality of UEs indicative of said non-paging group, wherein upon successful reception of the message UEs belonging to said non-paging group enter a sleep mode.

In accordance with another aspect of the present invention, there is provided a system comprising at least one Evolved NodeB (eNB) and a plurality of UEs communicatively coupled thereto, the eNB and the plurality of UEs belonging to an LTE wireless network, the system comprising: a partitioning module configured to partition the plurality of UEs into a plurality of groups; an advanced paging module configured to determine a non-paging group, the non-paging group including one or more of the plurality of groups which include UEs that will not be paged in an upcoming paging occasion; a messaging module configured to transmit a message from the eNB to the plurality of UEs indicative of said non-paging group; and a sleep control module operative on each of the plurality of UEs, the sleep control module configured to cause UEs belonging to said non-paging group, to enter a sleep mode upon successful reception of the message.

### BRIEF DESCRIPTION OF THE FIGURES

These and other features of the invention will become more apparent in the following detailed description in which reference is made to the appended drawings.

FIG. 1 illustrates an example operation in accordance with one embodiment of the invention.

FIG. 2 illustrates a method for influencing UE sleep operations in accordance with embodiments of the present invention.

FIG. 3 illustrates measured data of Discontinuous Reception (DRX) wake-up with a typical duration of 20 ms, according to embodiments of the present invention.

FIGS. 4A to 4C provide illustrations in relation to transmission in LTE systems which relate to embodiments of the present invention.

FIG. 5 illustrates a frequency division duplex (FDD) frame structure for LTE systems which relates to embodiments of the present invention.

FIG. 6 illustrates a system for influencing UE sleep operations in accordance with embodiments of the present invention.

FIG. 7 illustrate results related to a simulation for physical broadcast channel (PBCH) plus quick sleeping indication (QSI) transmission constellation with a first spreading sequence, in accordance with embodiments of the present invention.

FIG. 8 illustrates results related to a simulation for PBCH plus QSI transmission constellation with a second spreading sequence, in accordance with embodiments of the present invention.

FIG. 9 illustrates results related to a simulation for PBCH block error rate vs signal to noise ratio (SNR), in accordance with embodiments of the present invention.

FIG. 10 illustrates results related to a simulation for QSI block error rate vs SNR, in accordance with embodiments of the present invention.

FIG. 11 illustrates results related to a simulation for PSS and QSI block rate error (BLER) with binary phase shift keying (BPSK) modulation for QSI, in accordance with embodiments of the present invention.

FIG. 12 illustrates results related to a simulation for PSS and QSI BLER with quadrature phase shift keying QPSK modulation for QSI, in accordance with embodiments of the present invention.

FIG. 13 illustrates results related to a simulation for PSS and QSI BLER with circularly shifted Zadoff-Chu (ZC) sequences for QSI, in accordance with embodiments of the present invention.

### DETAILED DESCRIPTION OF THE INVENTION

### Definitions

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides means for improving the battery life of wireless terminal User Equipment (UE) in an LTE system while still allowing the UE to be contacted in a timely fashion by the LTE paging mechanism. As UEs expend substantial power while awake to monitor paging messages, the present invention provides a messaging mechanism, referred to herein as the Quick Sleeping Indication (QSI) for notifying UEs that they may sleep earlier than would otherwise be the case. Embodiments of the present invention may be used in conjunction with the Discontinuous Reception (DRX) mechanism of LTE.

The QSI may be regarded as a paging advanced warning signal. UEs are divided into groups and the QSI indicates particular ones of these groups. UEs belonging to groups that, in view of the QSI, may potentially be paged may be configured to remain in a receptive mode in order to receive the page. UEs belonging to groups that, in view of the QSI, are not anticipated to be paged imminently may be configured to go to sleep for a certain amount of time and conserve power since no page is anticipated. In various embodiments, the QSI operates as follows: First, the UEs are divided into a number (N_{grp}) of QSI groups. The QSI is sent a predetermined number ‘n’ of sub-frames before a given upcoming paging occasion (PO). The value ‘n’ may be configured to provide sufficient time that if a UE has moved, it can perform idle mode hand-off. The QSI indicates which QSI groups can go to sleep early (the non-paging group) because there will be no page for members of these groups in its upcoming PO. If the UE correctly decodes the QSI and if it indicates its QSI group as one of the groups which may go to sleep early, the UE goes back to sleep. Otherwise if the UE correctly decodes QSI and if it does NOT indicate its QSI group as one of these groups, the UE performs legacy DRX procedures to decode the PO. Finally, if the UE does not decode the QSI correctly or is unsure (e.g. correlation is below a quality threshold), the UE performs legacy DRX procedures to decode the PO.

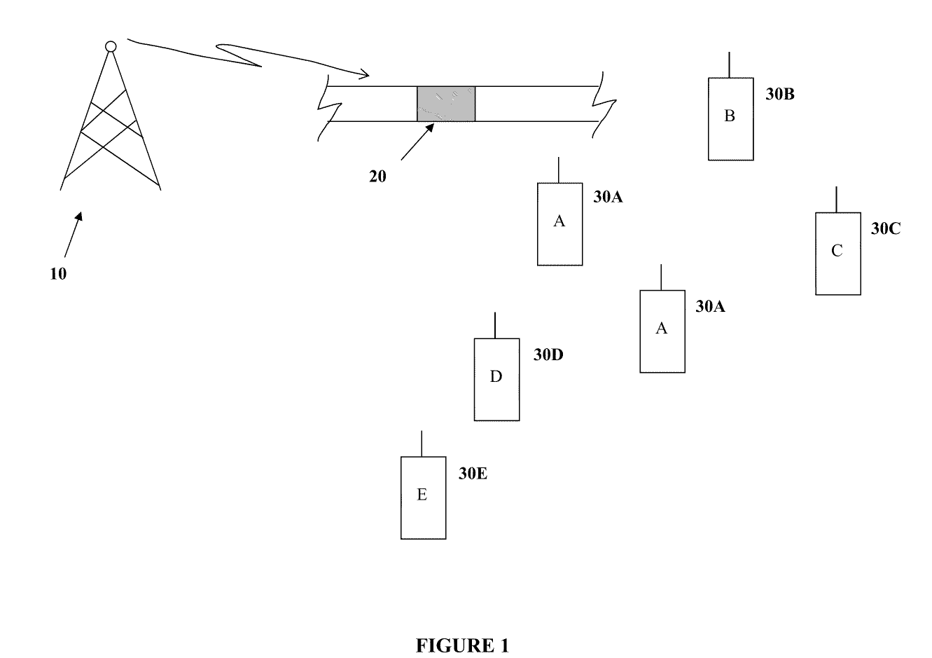

FIG. 1 illustrates an example operation in which an eNB 10 transmits a QSI message 20 indicative that a page for one or more UEs belonging to “Group B” 30B will be transmitted shortly, i.e. in an upcoming Paging Occasion. UEs belonging to “Group B” 30B and which successfully receive the QSI message 20 refrain from going to sleep early. UEs belonging to other groups, 30A, 30C, 30D and 30E and which successfully receive the QSI message determine that a page is not imminent and go to sleep early. However, all UEs, including “Group B” UEs 30B, which do not successfully receive the QSI message 20 refrain from going to sleep early. According to embodiments of the present technology, “Early” sleep corresponds to a UEs going to sleep prior to an upcoming Paging Occasion.

In various embodiments, the above method may be introduced with a very limited increase of additional errors that the QSI has on the paging success rate, since an error in decoding the QSI likely will only result in more power used rather than a paging error.

It is noted that, in case of poor signal or no signal, UEs could miss the QSI and would consequently remain awake to listen for the normal paging indications. In this case, the potential benefits of power saving due to the QSI would be lost, however pages would not be missed due to missing the QSI. The method of the present invention can be constructed so that reception of the QSI is not required for legacy UE operation. Since the QSI indicates which UEs are to go to sleep, rather than which UEs are to remain awake, a missed QSI will not likely result in a missed page. Furthermore, in various embodiments, the QSI is configured, for example via channel coding, to mitigate the potential for undesirably triggering UEs to go to sleep early due to potential bit errors in the QSI. In contrast, if the logic was described and treated as a quick paging indication which would indicate if a UE has an upcoming page in the subsequent paging occasion and this indication was missed, then UEs to be paged could go to sleep and miss their page.

Consequently, embodiments of the present invention provide for a method for influencing operation of a plurality of UEs in an LTE or similar wireless network. The method comprises partitioning the plurality of UEs into a plurality of groups. The method further comprises determining a non-paging group which includes one or more of the plurality of groups which include UEs that will not be paged in an upcoming paging occasion. The method further comprises transmitting one or more messages to the plurality of UEs indicative of said one non-paging group. The messages may be configured to inform certain UEs whether or not they may enter sleep mode earlier than they otherwise would. The method further comprises, for UEs belonging to said non-paging group, entering a sleep mode upon successful reception of the message.

As used herein, the term “sleep” generally refers to a state in which a UE powers down or powers off certain electronic components, such as its radio receiver, radio transmitter, and associated signal processing faculties, such as digital signal processors and/or microprocessors. Various sleep and wake configurations for LTE UEs would be readily understood by a worker skilled in the art, and embodiments of the present invention relate to the triggering of such sleep and wake configurations at a UE rather than the details of the sleep and wake configurations themselves.

In various embodiments, determining one or more of the plurality of groups which include UEs that will not be paged in an upcoming paging occasion may comprise accessing and processing information on upcoming paging messaging to be transmitted by the eNB. Paging information may be processed for example by accessing and processing a queue of pending paging messages.

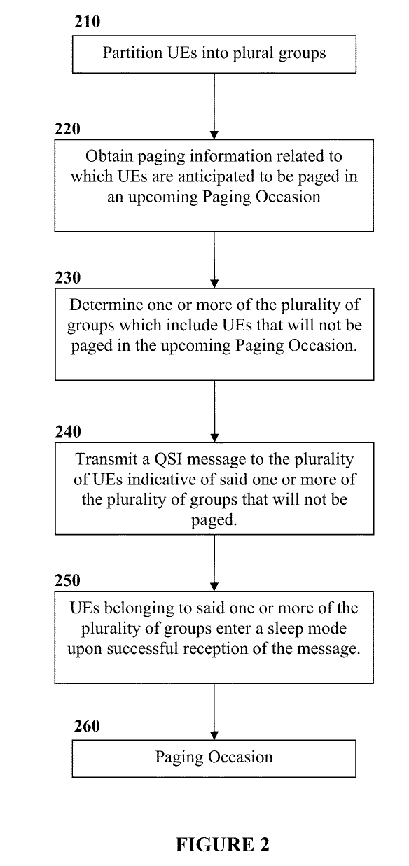

For example, FIG. 2 illustrates a method for influencing UE sleep operation in accordance with embodiments of the present invention. The method comprises partitioning 210 the plurality of UEs into a plurality of groups. The method further comprises obtaining 220 paging information related to which UEs are anticipated to be paged in an upcoming Paging Occasion. The method further comprises determining 230 one or more of the plurality of groups which include UEs that will not be paged in the upcoming paging occasion. The method further comprises transmitting 240 a QSI message to the plurality of UEs indicative of said one or more of the plurality of groups that will not be paged. The method further comprises, for UEs belonging to said one or more of the plurality of groups that will not be paged, entering 250 a sleep mode upon successful reception of the message. Subsequently, the Paging Occasion occurs 260. Steps 220 through 260 may then repeat for some or all subsequent Paging Occasions.

### Implementation Details:

Various select aspects of LTE systems, which are relevant to at least some embodiments of the present invention, are described below.

In LTE systems, during Discontinuous Reception (DRX) in Idle mode, a UE can potentially save more power since it is only required to monitor the Physical Downlink Control Channel (PDCCH) on one pre-determined paging occasion per DRX cycle, as described for example in “3^{rd} Generation Partnership Project; Technical Specification Group Radio Access Network; Evolved Universal Terrestrial Radio Access (E-UTRA); User Equipment (UE) procedures in idle mode (Release 12),” 3GPP TS 36.304 V12.0.0, 3^{rd} Generation Partnership Project, March 2014. The paging indication for the UE is received through Paging Radio Network Temporary Identifier (P-RNTI) on PDCCH. If it does not find P-RNTI, it goes back to sleep. If it finds P-RNTI, the UE proceeds to decode Physical Downlink Shared Channel (PDSCH). The PDSCH will contain the SAE Temporary Mobile Subscriber Identity (S-TMSI) or International Mobile Subscriber Identity (IMSI) list of UEs being paged. If the UE finds its S-TMSI or IMSI ID in the list, then it knows that it is paged. If not, it will go back to sleep.

Though the DRX operation in Idle Mode may provide significant power savings, the decoding complexity is considered substantial since the UE needs to decode the PDCCH to find P-RNTI. PDCCH requires 44 blind decodes and it occupies the full eNB bandwidth. Hence a full scale Fast Fourier Transform (FFT) may be required to obtain the PDCCH, which consumes a significant amount of UE processing power. Additionally, the UE wake-up time may require appropriate timing synchronization with the eNB. This may consequently require Primary Synchronization Signals (PSS) and Secondary Synchronization Signals (SSS) detection (correlation with the previously obtained PSS and SSS) to determine the cell ID and timing alignment. The UE may also decode the Physical Broadcast Channel (PBCH), obtain the Master Information Block (MIB) to confirm the cell ID and determine the system frame number (SFN). The UE generally requires some time for Radio Frequency (RF) warm up and timing synchronization; it cannot directly wake-up at the pre-determined paging occasion and start decoding PDCCH. Therefore, a Quick Sleeping Indication (QSI) as described herein may be useful to indicate to the UE whether it can go back to sleep early when there is no upcoming paging message, or to indicate that the UE should remain awake to decode PDCCH. This may assist in reducing the power consumption of UEs in 3GPP LTE wireless communication systems, although it is appreciated that the concept can be also be applied, with suitable modification, in comparable existing or future wireless communication systems.

Embodiments of the present invention are applied to systems comprising Machine Type Communication (MTC) UEs. In this case there may be a large number of MTC UEs requiring paging information. The Paging Channel (PCH) sent on PDSCH can accommodate a maximum of 16 UE identities. The eNB would require more time and resources to send the paging information to all the UEs. Therefore, the probability that a UE or a group of UEs is paged on every paging occasion is low. However, the UEs would typically expend power monitoring the PDCCH multiple times before getting a valid paging message. In such cases, QSI as described herein may be used to indicate that one or more groups of UEs can go to sleep early since they do not have an impending paging message. This may assist in reducing the power consumption of the UEs.

In some embodiments, to achieve “early closure”>95% of the time, assuming a paging rate of 1 per Hr per UE and 100,000 UEs per sector, 6 groups of UEs are required. Early closure in this sense refers to a performance metric in which >95% of UEs indicated in the QSI successfully go to sleep early.

In some embodiments, it is desirable to provide the present invention in a manner that satisfies some or all of the following criteria: Implementation of the present invention can require limited or minimal standard changes; Performance degradation of legacy UEs due to implementation of the present invention can be less than 0.1 dB or less than 0.2 dB; Reduction in UE energy consumption due to reduced average powered-on time and/or reduction in central processing unit (CPU) calculations can be achieved; A Missed Paging Performance can be achieved which is less than 0.1% greater than the current performance without the technology according to the present invention implemented; An effect of quick return to sleep for UEs can be achieved at least 95% of the time when at least 6 QSI groups are implemented; A network resource usage of less than 2% for 1 QSI group can be achieved; Scaling of resources with the number of groups supported can be achieved; The present invention is effective when UEs are mobile; and Embodiments of the present invention can be implemented with little to no significant additional latency.

In some embodiments, and for reference, implementation details of the LTE DRX Procedure when UE is always mobile may be characterized as follows. The UE is generally required to wake up well before the paging occasion in case idle mode hand-off has occurred, so that it can scan other channels. Time requirements of the DRX Procedure may comprise: Time required for radio settling and crystal tolerance, requiring <<100 us; Decoding of PSS/SSS and obtaining Pilot estimate on the MRU (Most Recently Used) channel, requiring 6 ms. It is noted that this requires about lms if the UE hasn't moved and is in coverage but more likely allocates 2 copies so 6 ms may be used as a conservative estimate. It is further noted that this is a correlation so it may not be possible to know for sure if PSS/SSS detection is correct until PBCH is decoded. As the UE is fully mobile this operation is anticipated to fail; Decoding of PSS/SSS on 3 neighbor channels, requiring 6 ms*3=18 ms; Decoding of PBCH to confirm PSS/SSS and Cell ID, requiring 40 ms; and Decoding of PDCCH Paging Occasion (PO), requiring <9 ms. Thus the Maximum Total Decode Time for mobile UEs may be about 6+18+40+9=73 ms.

In some embodiments, and for additional reference, implementation details of the LTE DRX Procedure when a UE is mostly stationary may be characterized as follows. Assuming the UE can tell with adequate probability when it is stationary, a much shorter process can be followed compared to the case where the UE is mobile. One possible mobility detector may utilize wireless signal analysis, wherein if PSS/SSS correlation falls below a threshold or PBCH fails to decode, the UE will assume it is mobile and follow the mobility DRX procedure until no Cell ID changes are observed for a predetermined number (e.g. 100) of DRX cycles. Time requirements of the DRX Procedure in this case are characterized as follows. Time required for radio settling and crystal tolerance is <<100 us. Next, decoding of PSS/SSS and obtaining a Pilot estimate on the MRU (Most Recently Used) channel is performed, requiring lms. Notably, if the PSS/SSS correlation fails, it is likely the UE will miss decoding the PO. Next, decoding of the PBCH is performed to confirm PSS/SSS and Cell ID, requiring 0 additional milliseconds. This is optional if PSS/SS correlation is strong, since the Cell ID can be assumed. This may also be performed in parallel to PSS/SSS detection. Furthermore, even with just one 10 ms segment of PBCH the decoding should pass at least occasionally, confirming sync and cell ID. Alternatively, if PBCH continues to fail because it is in a very bad coverage area the UE would typically need to wake up earlier but likely this would only happen occasionally. Finally, Decoding of PDCCH PO is performed, requiring a maximum of 9 ms. The Total Decode Time for mostly stationary UEs is therefore about 1+9=10 ms. It is noted that, if the UE moves to another cell, it will miss that Paging Occasion.

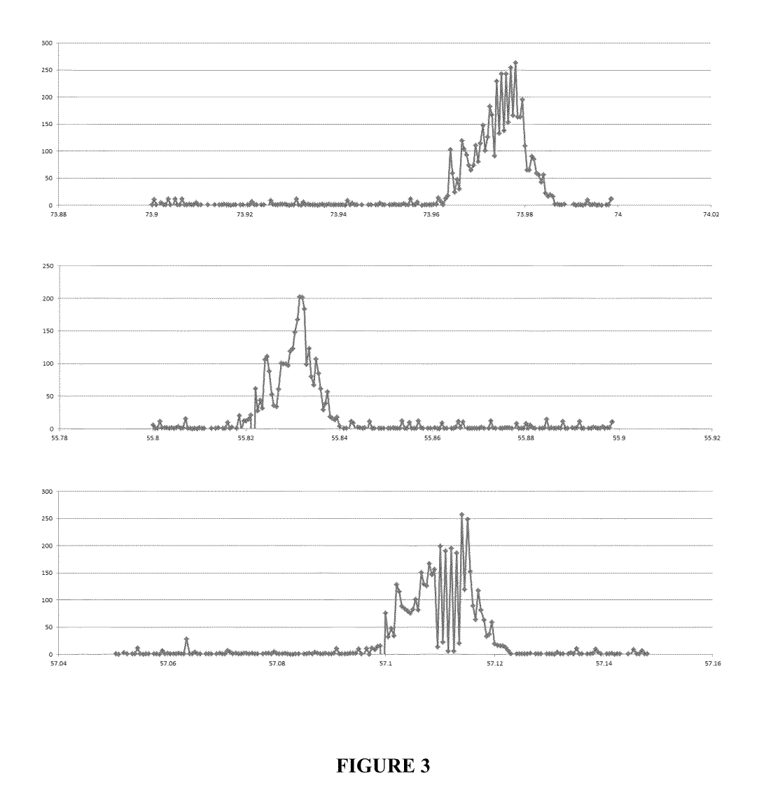

FIG. 3 illustrates measured data of DRX wake-up with a typical duration of 20 ms, according to embodiments of the present invention.

For further reference, additional background information on PSS for various LTE implementations is now provided, and which may relate to various embodiments of the present invention. In such implementations, three PSS sequences are used to indicate the cell identity within the group, and 168 SSS sequences are used to indicate the identity of the group. Zadoff-Chu sequences are widely used in LTE, including for the uplink reference signals and random access preambles because of their Constant Amplitude Zero Autocorrelation (CAZAC) property. Other sequences may have this property but PSS is a suitable choice because the eNB can generate this already and UE can detect it.

Furthermore, Zadoff-Chu sequences for the frequency-domain length-63 sequence may be characterized by the equation: ZC⁶³_{M}(n)=exp[−jπMn(n+1)/63], where n=0, 1, . . . , 62. The selected roots M for the three sequences used are M=29, 34, 25. In particular, these sequences are considered suitable as they have a low frequency-offset sensitivity. Furthermore, PSS may be relatively easily detected during the initial synchronization with a frequency offset up to ±7.5 kHz.

For further reference, additional background information on PDCCH for various LTE implementations is now provided, and which may relate to various embodiments of the present invention. In such implementations, a Resource Element Group (REG) is defined as four consecutive Resource Elements (RE). The smallest PDCCH format 0 has 1 Control Channel Element (CCE)=9 REGs=9*4=36 REs. Downlink Control Information (DCI) Format 1 has 2 CCE=18 REGs=72 REs which is the same as PSS uses. A total of 8 or 11 REGs are present per Physical Resource Block (PRB). Each Control Channel Element (CCE) contains 9 REGs, which are distributed across the first 1/2/3 (or 4 if needed for a 1.4 MHz channel) Orthogonal Frequency Division Multiplexing (OFDM) symbols and the system bandwidth through interleaving to enable diversity and to mitigate interference. This interleaving may facilitate QCI (quick close indication).

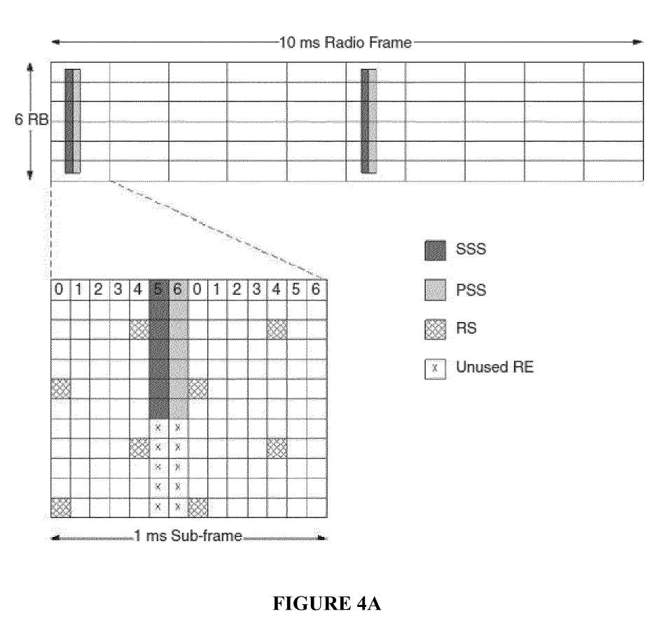

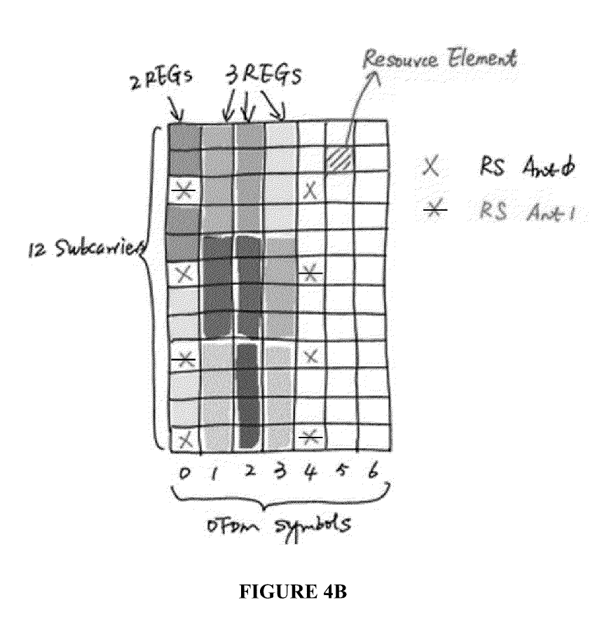

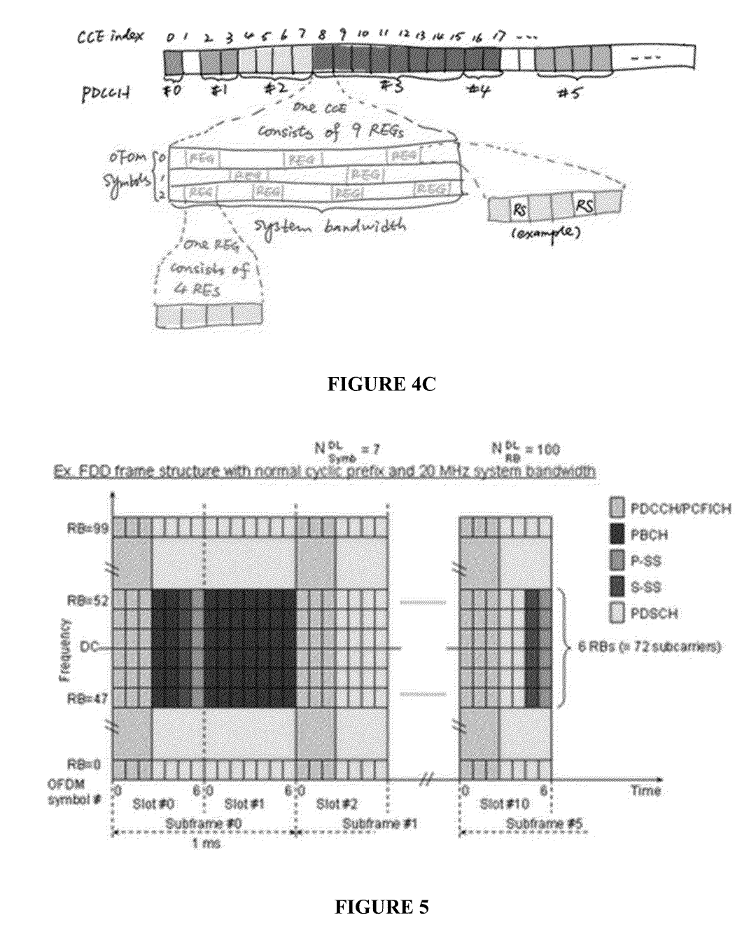

FIGS. 4a to 4c provides illustrations in relation to the above information, in relation to transmission in LTE systems which relate to embodiments of the present invention.

### UE Grouping Mechanisms:

As mentioned above, embodiments of the present invention comprise partitioning the plurality of UEs into groups, such that each UE belongs to a given group. UE grouping may be performed during an initial state, prior to messaging. UE grouping may be static or updated at a low frequency relative to QSI messaging frequency. Alternatively, UE grouping may be relatively dynamic, for example based on conditions or configuration information mutually observed by both the UEs and the eNB, such as channel quality. Generally, each UE may be configured to discern whether or not a given QSI message indicates its group. The wireless network infrastructure, for example including the eNB, may further be configured to determine which group each of the plurality of UEs belongs to, for example via lookup table or other mapping function.

Various approaches may be used for partitioning the plurality of UEs into groups. In some embodiments, the UEs may be grouped using an identifier which is substantially unique for each UE. For example, the International Mobile Subscriber Identity (IMSI) may be used as the identifier, and the UE Group Id (UEG Id) may then be given by the Equation: UEG Id=IMSI mod N_{grp}. As another example, the UE Id may be used as an identifier, and the UEG Id may then be given by the Equation: UEG Id=UE Id mod N_{grp}, where UE Id=IMSI mod 1024. As another example, the Cell Radio Network Temporary Identifier (C-RNTI) may be used as an identifier, and the UEG Id may then be given by the Equation: UEG Id=C-RNTI mod N_{grp}. As would be readily understood, “x mod y” refers to the modulo operation.

In some embodiments, UEs may be grouped based on the known channel quality. It is noted that there is generally no Channel Quality Index (CQI) feedback mechanism for UEs in idle mode. Therefore, indications of channel quality would have to be performed by some other indirect measurement. For example, at least one group may be defined to encompass substantially all of the devices known to be operating in a coverage enhancement (CE) mode. UEs having a channel quality within a certain range could be in the same group. Such a grouping mechanism is analogous to grouping UEs according to their distance from the eNB. Various coverage enhancement modes for LTE may be readily understood by a worker skilled in the art, for example to provide and/or retain UE connectivity to the cell network in marginal signal conditions.

In other embodiments, UEs may be grouped based on an Application profile (e.g. frequently or infrequently mobile terminated (MT)). This allows the network to place the infrequently MT UEs together, which in turn can result in increased power savings.

Other approaches for assigning each UE to one of a plurality of nominal groups may be used as would be readily understood by a worker skilled in the art.

### UE Addressing Mechanisms:

As mentioned above, embodiments of the present invention comprise transmitting a message, such as a QSI, to the plurality of UEs indicative of a non-paging group which includes one or more of the plurality of groups which include UEs that will not be paged in an upcoming paging occasion.

In various embodiments, the QSI indicates one or more groups of UEs (which include UEs which will not be paged in the upcoming PO) by addressing these groups. Predetermined bits contained in the QSI may be used for addressing purposes and may be set in a pattern to indicate one or more group identifiers. By processing the bits of the QSI, UEs may determine whether their group is indicated by the QSI and react accordingly.

In some embodiments, ‘M’ bits are used to address N_{grp}=2^{M} UE groups, and one group is addressed with each QSI message. For example, by using M=4, UEs may be partitioned into 16 groups, and one group may be addressed at a time.

In other embodiments, a bit map between QSI and UE groups can be used. That is, each of the ‘M’ addressing bits of the QSI indicates exactly one UE group. In this case, N_{grp}=M. For example, using M=4, UEs can be grouped into 4 groups, and all 4 groups or any subset thereof may be addressed with each QSI message. For example, ‘1001’ may indicate that groups numbered 1 and 4 are being addressed.

In other embodiments, each bit of the QSI message can be used to address multiple UE groups. Define ‘N_{bit}’ as the number of groups addressed by each bit. Then, N_{grp}=N_{bit}*M. For example, by using M=4 and N_{bit}=3, the UEs may be grouped into N_{grp}=12 groups, and all 12 groups may be addressed with each QSI message, but N_{bit} groups receive identical information.

Other approaches for addressing UE groups, or combinations of approaches such as described above, may be used as would be readily understood by a worker skilled in the art.

### QSI Transmission and Reception Mechanisms:

As described above, a message, nominally the QSI, is transmitted to the plurality of UEs and is indicative of one or more of the plurality of UE groups which include UEs that will not be paged in an upcoming Paging Occasion (PO). The message may be a broadcast message and may be communicated according to one of a variety of mechanisms, for example as described below.

In some embodiments, the QSI may be transmitted via the LTE Physical Broadcast Channel (PBCH), for example by using reserved bits in the MIB or by spreading the QSI using orthogonal codes or using repetition, or using repetition and forward error correction (FEC).

In some embodiments, the MIB transmitted on PBCH contains 24 bits out of which 10 are reserved bits. By using, for example, M=4 out of 10 reserved bits, support for from N_{grp}=4 to N_{grp}=16 UE groups can be provided, respectively, depending on which of the above-mentioned addressing mechanisms is used. This approach provides the feature that the QSI is decoded along with PBCH without affecting the performance of PBCH decoding. There may be more delay in addressing a larger number of groups than can be indicated in each MIB because it will be necessary to address the groups in sequential MIB transmissions.

In some embodiments, in relation to spreading the QSI message using orthogonal codes, an orthogonal signal indicative of the QSI may be sent by the eNB in parallel with the PBCH. The orthogonal sequence corresponding to the QSI may be transmitted along with the PBCH at a low power. The orthogonal signal can then be detected by the UE, de-spread and correlated against known possible QSI codes to get a correlation of the QSI value.

It is noted that the MIB typically has a large number of possible combinations: 6 Bandwidths*2 Physical Hybrid-ARQ Indicator Channel (PHICH) Duration*4 PICH Resolution*256 SFN=12,288 combinations. Additionally, there are 3 antenna configurations (N_TX=1, 2 or 4). This may result in up to 12,288*3=36,864 different combinations of MIB content. Since the MIB symbols are scrambled by the Cell ID, there are 36,864 combinations per Cell ID. The Cell ID is determined by PSS and SSS which are independent of the MIB. The encoded and rate matched PBCH consists of 1920 bits which are sent over 40 ms using Quadrature Phase Shift Keying (QPSK) modulation which makes the PBCH a complex vector of length 960. Also each 10 ms copy of PBCH, which is a complex vector of length 240, can be decoded independently to obtain the MIB.

For a given Cell ID and a 10 ms copy of PBCH, the number of combinations can be represented using a 36,284*240 complex matrix. The rank of this matrix tends to be relatively low (for example about 100 according to some observations of simulation results). This suggests that sequences orthogonal to PBCH combinations per Cell ID can often be derived from the null space of this matrix.

For ‘M’ bits of QSI, 2^{M} orthogonal sequences may be required. In cases where there are 504 Cell Ids, the total number of QSI sequences is therefore 504*2^{M}, being a complex vector of length 240. Also, in cases where there are four different 10ms copies of PBCH, if each complex number is represented using 32 bits, this scheme would require a table of (4*504*2^{M}*4*240/1024) kB. For example, with 4 QSI bits, there are 504*16=8064 QSI sequences which would correspond to a table of 29.53 MB.

In some embodiments, the effect of such a spreading sequence transmitted in the background may be characterized as follows. The orthogonal sequence corresponding to the QSI can be sent along with the PBCH at a very low power. Let ‘S_{ref}’ denote the power of the PBCH signal without paging and N denote the noise power. Let ‘Sₚ’ denote the power of the QSI signal. The signal to noise ratio of the PBCH signal without QSI is SNR=S_{ref}/N. The SNR of the QSI signal can be calculated as SNR=Sₚ/N. If QSI is added to PBCH, the power of the PBCH signal becomes S_{new}=(1−P)S_{ref} where ‘P’ is the fraction of the PBCH power used for QSI. The QSI signal can be like interference to the PBCH signal. The signal to interference plus noise ratio SINR is given by:

$$SINR = \frac{( 1 - P ) \cdot {S}_{ref}}{P \cdot {S}_{p} + N} ; SINR = \frac{( 1 - P ) \cdot {S}_{ref} / N}{( P \cdot {S}_{p} + N ) / N} ;$$

$$SINR = \frac{( 1 - P ) \cdot SNR}{P \cdot {SNR}_{p} + 1}$$

Since the QSI sequences are orthogonal to PBCH, the interference denoted by P·SNRₚ=0. Therefore, SINR=(1−P)·SNR and the loss in PBCH detection performance is (1−P). For example, if P=0.05, then SINR=0.95*SNR and the loss in PBCH detection performance in dB is about 10*log₁₀(0.95)=0.22 dB which can be considered small.

It is noted that the orthogonal spreading approach described above may require significant memory if all the sequences for all cell IDs are stored at the UE (for example, possibly about 30 MB in flash memory to store sequences). This memory requirement may be reduced to about 60 kB if sequences are calculated dynamically given the cell ID, however such dynamic calculation may be computationally demanding. Alternatively, for stationary UEs, the about 60 kB table may be downloaded from the eNB (for example once). It is further noted that this approach likely does not affect other channels and hence changes to the LTE standard may be limited. It is further noted that some Legacy UE performance degradation may be present, but current indications are that this degradation may be less than about 0.1 dB or 0.2 dB. In one embodiment, legacy UE performance degradation is about 0.22 dB for a static channel and for 5% power.

In one simulation scenario, average “ON” time of UEs using the above scheme was about 1 ms, missed pages were increased by less than about 0.1% from current performance, Quick sleep successfully occurred about 95% of the time, and network resources used <2% (for 1 group) was negligible.

In some embodiments, in relation to spreading the QSI message using repetition, the QSI bits are repeated at a very low power across the PBCH symbols. The ‘M’ bits of the QSI are spread over 480 bits of each 10 ms copy of the PBCH. Hence the spreading factor SPF=480/M. Due to the large spreading gain, the QSI signal may be detected after the detected PBCH signal is subtracted from the received signal.

In some embodiments, the SNR to decode the QSI signal spread by repetition, considering that the PBCH signal is subtracted from the received signal is P*SNRₚ*SPF. For example, with M=4 and P=1/20, SPF=120 and the SNR to decode the QSI signal will be 6*SNRₚ which is 10*log₁₀(6)=7.78 dB more than the original QSI signal SNR.

In addition to repetition, a spreading sequence may be used to attempt to ensure uniform distribution of phase of the QSI signal. However, in this method the interference denoted by P·SNRₚ is typically greater than zero and less than one. Therefore, the loss in performance may be given as (1−P)/(P·SNRₚ+1).

In some embodiments, in relation to spreading the QSI message using repetition and Forward Error Correction (FEC), the QSI message is spread using repetition as described above, but the QSI bits are encoded using an error correction coding scheme. So, the ‘M’ QSI bits results in ‘M_{enc}’ encoded bits and the spreading factor is 480/M_{enc}. The SNR to decode the QSI signal considering that the PBCH signal is subtracted from the received signal is reduced by a factor of (M/M_{enc}), but the FEC makes up for the loss in SNR. Also, if the number of QSI sequences is small, a Maximum Likelihood (ML) decoding scheme can be used for FEC decoding.

For example, with M=4, P=1/20 and (8,4) Extended Hamming Code for FEC, M_{enc}=8 and SPF=60. The SNR to decode paging is P*SNRₚ*SPF=3*SNRₚ=4.77 dB which is 3 dB less than the SNR when the QSI message is spread using repetition but not encoded. However, the FEC helps in detecting the paging signal.

It is further noted that, in the above embodiments employing spreading of the QSI, the total power available for PBCH transmission is assumed to be unchanged and a fraction of the available PBCH power is used for QSI. If the eNB can afford additional power for QSI, there may be little or no loss in PBCH decoding performance.

In a second set of embodiments, the QSI may be transmitted via resources related to the LTE Primary Synchronization Signal (PSS) and/or the Secondary Synchronization Signal (SSS).

In some embodiments, paging on unused sub-carriers of the PSS may be carried out. The synchronization signals in LTE, namely the Primary Synchronization Signal (PSS) and Secondary Synchronization Signal (SSS), occupy 62 out of 71 sub-carriers available. Excluding the DC carrier, there are therefore 8 unused sub-carriers. The QSI may therefore be transmitted on these unused subcarriers in some embodiments. The following methods use the 8 unused sub-carriers to transmit paging information. It is assumed that M=4 bits of QSI are used, indicating from N_{grp}=4 to N_{grp}=16 different groups of UEs, depending on the addressing mechanism used (as described elsewhere herein). Table I outlines these methods.

TABLE I

| | Modulation | | Total | Error |
|---|---|---|---|---|
| | used for | Synchronization | Number of | Correction |
| Method | Paging | Symbols Used | Repetitions | Coding Used |
| 1 | BPSK | PSS Only | 2 | None |
| 2 | BPSK | PSS and SSS | 4 | None |
| 3 | BPSK | PSS Only | 2 | (8, 4) Extended |
| | | | | Hamming Code |
| 4 | BPSK | PSS and SSS | 4 | (8, 4) Extended |
| | | | | Hamming Code |
| 5 | QPSK | PSS Only | 4 | None |
| 6 | QPSK | PSS and SSS | 8 | None |
| 7 | QPSK | PSS Only | 4 | (8, 4) Extended |
| | | | | Hamming Code |
| 8 | QPSK | PSS and SSS | 8 | (8, 4) Extended |
| | | | | Hamming Code |

It is noted that methods 5 to 8 use QPSK and twice the number of repetitions compared to methods 1 to 4. Accordingly, methods 5 through 8 are substantially equivalent to 1 through 4.

In various embodiments, the PSS is a Zadoff-Chu sequence and the SSS is an m-sequence, both having unit power per sub-carrier. When 8 sub-carriers are used for QSI, the modified SNR for PSS/SSS is given by SNR_{sync}=(1−8/62)·SNR_{orig}. Therefore, the change in PSS/SSS SNR can be computed as: SNR−SNR_{orig}=10*log₁₀(1−8/62)=−0.6 dB. Therefore, the PSS/SSS SNRs are degraded by about 0.6 dB.

In some embodiments, the above methods are characterized in that there are no changes to the current channel, since the methods use REs not currently in use. Performance degradation relative to legacy UE performance may be zero if PSS Power Spectral Density (PSD) boost not used, or 0.6 dB if PSS PSD boost is used, and Pₜₒₜ is the same. If Pₜₒₜ can increase then the degradation may be held at 0 dB. Average UE “ON” Time may be reduced by 2 symbol times.

In some embodiments, paging on the PSS using cyclically shifted Zadoff-Chu (ZC) sequences may be carried out. PSS is a ZC sequence given by exp(−j*pi*u*n*(n+1)/63) where u=[25, 29, 34]. The ZC sequences have the property that any cyclically shifted version of a ZC sequence is orthogonal to the original sequence. This property is used for Physical Random Access Channel (PRACH). For transmitting ‘M’ bits of quick paging information per PSS, (2^{M}−1) cyclically shifted sequences of the PSS are required and the original PSS sequence can be used to indicate the all-zero message. If the paging sequence indices per PSS be denoted by nₚ, then, nₚ=1, 2, . . . , (2^{M}−1). The cyclic shift index is determined by n_{cs}=(64/2^{M})*nₚ=(2^{6-M})*nₚ, which puts a limit on M so that M<=5. Therefore, the paging sequences can be determined as follows:

Paging_Sequence(nₚ)=circshift(PSS_Sequence, (2^{6-M})*nₚ)

The total number of sequences used for QSI may be (2^{M}−1)*3 since there are 3 PSS sequences. Considering 32 bits to represent a complex number, the additional memory required to store these sequences is ((2^{M}−1)*3*62*4/1024) kB since each sequence is of length 62. For example, with M=4, this embodiment may result in a total of 45 sequences and require an additional memory of about 10.9 kB.

The paging detection may be performed through Maximum Likelihood Decoding. The received sequence is correlated with each reference sequence. The reference sequence which gives the maximum correlation is considered to be the transmitted paging sequence and the corresponding paging information is determined. The paging sequence detected is denoted herein by P_{det}.

The PSS detection may be performed as follows. Let S₀, S₂, . . . , S₄₇ denote the 48 sequences, including 3 original PSS, i.e. S₀, S₁₆ and S₃₂, plus 45 new sequences. The sequences are arranged such that S₀ to S₁₅ belong to cyclically shifted versions of PSS₁, S₁₆ to S₃₁ belong to cyclically shifted versions of PSS₂ and S₃₂ to S₄₇ belong to cyclically shifted versions of PSS₃. Then, the PSS sequence transmitted may be determined as follows:

PSS_Sequence_Index=ceil(Paging_Sequence_Index/16).

The above method for decoding PSS is a hard-decision rule. Alternatively, a soft decoding scheme based on Euclidean distance from the Paging sequences may be implemented. The method comprises choosing the decoded PSS as the highest-probability candidate out of PSS₁, PSS₂ and PSS₃, in accordance with the following equations:

$$Prob \{ PSS = {PSS}_{1} \} = {\sum }_{k = 0}^{15} {e}^{- \frac{{( Y - {S}_{k} )}^{2}}{{σ}^{2}}} ;$$

$$Prob \{ PSS = {PSS}_{2} \} = {\sum }_{k = 16}^{31} {e}^{- \frac{{( Y - {S}_{k} )}^{2}}{{σ}^{2}}}$$

$$Prob \{ PSS = {PSS}_{3} \} = {\sum }_{k = 32}^{47} {e}^{- \frac{{( Y - {S}_{k} )}^{2}}{{σ}^{2}}}$$

$${PSS}_{det} = {argmax}_{i} ( Prob \{ PSS = {PSS}_{i} \} )$$

$$where i = 1 , 2 and 3$$

In a third set of embodiments, the QSI may be transmitted via dedicated resources allocated in a known location in time and/or frequency and used for this purpose.

In a first one of the third set of embodiments, the QSI is transmitted as or in place of the PSS in one control channel element (CCE) of the PDCCH. It is noted that the CCE to REG mapping is interleaved and sent across the entire PDCCH 3-4 frames. It may be required to decode PSS and SSS before QSI to achieve frequency synchronization. This may be avoided in some embodiments by using use a PSS-like signal.

In some embodiments, the UE “ON” time associated with this approach is 3 to 4 symbol times+radio warm-up time and clock drift, i.e. about (3 or 4)/14+0.01+0.01 or about 0.31 ms. This can be compared to the currently measured 20 ms UE “ON” time.

In some embodiments, the overhead required for the above approach is approximately as follows. Assume the QSI transmitted as a PSS is the same size as one PSS. Also note that PSS fits in 6 PRB but almost 1 PRB is unused (10 REs). The usage is 62 REs symbols (7*2+4*12), to yield less than 72 REs. Further, one Frame and one PRB correspond to 12 tone*14 sym*10 SF=1680. For various standard system bandwidths this results in a resource allocation to this purpose of: For 1.4 MHz, 72/(1680*6)=0.7% (for 1 repeat). For 5 MHz, 72/(1680*25)=0.17%. For 10 MHz, 72/(1680*50)=0.086%. For 20 MHz, 72/(1680*100)=0.043%.

In some embodiments, the number of groups supported is 64 possible re-using current PSS, so 6 groups. From 6 to 64 groups can be supported without requiring significant changes to timing structure. As such there are 64 possible PSS sequences that the eNB can send, namely 64 sequences can be represented by a 6 bit number (2̂6=64). Accordingly it can support 6 groups using a 6 bit bitmask. To support more groups, eNB may be configured to send QSI more than once per SF (e.g. at SF0 and SF5 with PSS/SSS) and also more than once per SF. This allows for a large number of groups, however the resources used increases with the number of groups. This configuration may be sent to the UE directly or via SIB indication.

In some embodiments, for deeper coverage the QSI may be repeated across frequencies and/or in time. It is desirable to avoid spanning subframes by the QSI, as this may result in longer “ON” time for the UEs. In one embodiment, repetition may be up to 7 times for 1.4 MHz channel (for example, if PDCCH=4 symbols there are a total of 7 CCE in one SF so this can be repeated 7 times (11 REGS per PRB*6 PRBs/9 REG CCE 66/9=7). In one embodiment, if there are more than 5 QSI groups are supported, one slot can repeat less than another slot. Finally, it is noted that, if PSS is used for the QSI then UEs may see QSI as the main PSS but the interleaving of the CCEs may make QSI appear unlike a PSS to a legacy UE.

In some embodiments, various measures may be taken to mitigate the probability of False QSI detection from neighbouring cells. For example, neighbouring cells may use a different sequence, difference CCE allocations, different time allocations, and/or UEs may be configured to decode PSS/SSS.

In some embodiments, the QSI is transmitted as a DCI in PDCCH in symbols immediately prior to PSS/SSS. This may be done in particular for SF#5 when PBCH is not sent. In this embodiment, the UE may be configured to buffer PDCCH samples until the PSS/SSS is decoded in order to obtain timing, frequency offset, and channel information. The UE “ON” time in this approach is anticipated to be about 0.5 ms. Further, by using the Cyclic Redundancy Check (CRC) the UE may be configured to determine whether it is synchronized. This may mitigate false detections.

Alternatively, the QSI may be transmitted as a DCI in PDCCH in symbols immediately following PSS/SSS, but otherwise similarly to the above. This can be performed twice for frame SF#1 and SF#6. However, the UE ON time is anticipated to be about lms in this case.

In some embodiments, the QSI is transmitted as a PSS in PDSCH. The SIB may allocate fixed PRBs for QSI. RE in 1 PRB pair may be about 132 REs. The minimum definable Resource Block Group (RBG) size, for Type 0 Resource allocation, may be 1, 2, 3 or 4 for downlink bandwidth ranges of 0-10, 11-26, 27-63 and 64-110, respectively. Resource usage for a 1.4 MHz system may be 132/10080=1.3%. Resource usage for a 5 MHz system may be 132*2/(10080/6*25)=0.6% Resource usage for a 10 MHz system may be 132*3/(10080/6*50)=0.4%. Resource usage for a 20 MHz system may be 132*4/(10080/6*100)=0.3%. It is observed that this approach scales with bandwidth. In some embodiments, the QSI is transmitted in time rather than frequency, thereby reducing the chance to be misinterpreted as a true PSS by legacy UEs.

In some embodiments, the QSI is transmitted as a DCI message in PDCCH. A new small DCI message, with no resource allocation needed, may be sent on the PDCCH. A new RNTI for each new QSI group may be reserved. SIB or higher layer signaling may indicate to a UE when the QSI is transmitted as a DCI message in PDCCH. The UE “ON” time in this case may be about 2 ms if the QSI is sent in the SF after PSS/SSS. This approach may require relatively few changes to the UE and no physical layer protocol changes. Additionally, CRC on DCI may be used to ensure that the UE knows it can go to sleep, thereby avoiding additional PO failures.

In some embodiments, the QSI is transmitted as a higher layer signalling message in PDSCH. A new, small higher layer message may be transmitted on the PDSCH indicating groups that can go to sleep (i.e. the QSI). PDSCH resources may be scheduled via PDCCH or configured via SIB or sent via higher layer signaling. The UE “ON” time in this case may be about 2 ms if the QSI is sent in the SF after PSS/SSS. This approach may also require relatively few changes to the UE and no physical layer protocol changes. Additionally, cyclic redundancy check (CRC) on PDSCH may be used to ensure UE knows it can go to sleep, thereby avoiding additional PO failures.

### Power Savings in UEs:

UE power savings resulting from implementation of some embodiments of the present invention may be related to the following.

In Idle Mode DRX, the power saving is mainly due to reduced fast Fourier transform (FFT) size and elimination of 44 blind decodes on PDCCH when there is no paging information for the UE. PDCCH occupies the entire eNB bandwidth and requires a full size FFT. The PBCH, PSS and SSS occupy 72 sub-carriers and a fixed bandwidth of 1.4 MHz. PBCH is transmitted on 4 symbols while PSS and SSS are transmitted on one symbol. This is illustrated for example in FIG. 5. For example, if the eNB bandwidth is 20 MHz, the PDCCH requires 2048 point FFT and will occupy 2 or 3 symbols. An FFT requires on the order of Nlog₂N, i.e. O(Nlog₂N) computations. Thus, the number of FFT computations per PDCCH symbol is about 2048*log₂(2048)=22528 which can be saved using QSI.

In connected mode DRX, the UE has an ON time of 100 ms to monitor the PDCCH for paging. So a QSI mechanism as described herein may be beneficial due to the reduction in FFT processing and the elimination of PDCCH decoding when there is no P-RNTI on PDCCH. Additionally, a UE using the QSI mechanism as described herein may be configured to only wake up periodically to check for QSI. This may reduce the effective “ON” time of the UE which further helps in saving power.

### Invention Implementation:

Various embodiments of the present invention may be implemented as a computer-implemented method, namely a method whose steps are implemented by computing devices such as by a combination of LTE network infrastructure devices such as eNBs or related infrastructure equipment as well as LTE wireless terminal UEs such as MTC UEs or other UEs. The method may thus be implemented in a distributed manner. The computing devices may implement the method by executing, by a microprocessor, computer instructions stored in memory and operating various electronics associated with and controlled by the computing devices accordingly. Additionally or alternatively, some or all of the operations of the computing devices may be executed by electronics executing firmware instructions or dedicated electronics hardware configured to operate in a predetermined manner when presented with predetermined patterns of electronic inputs.

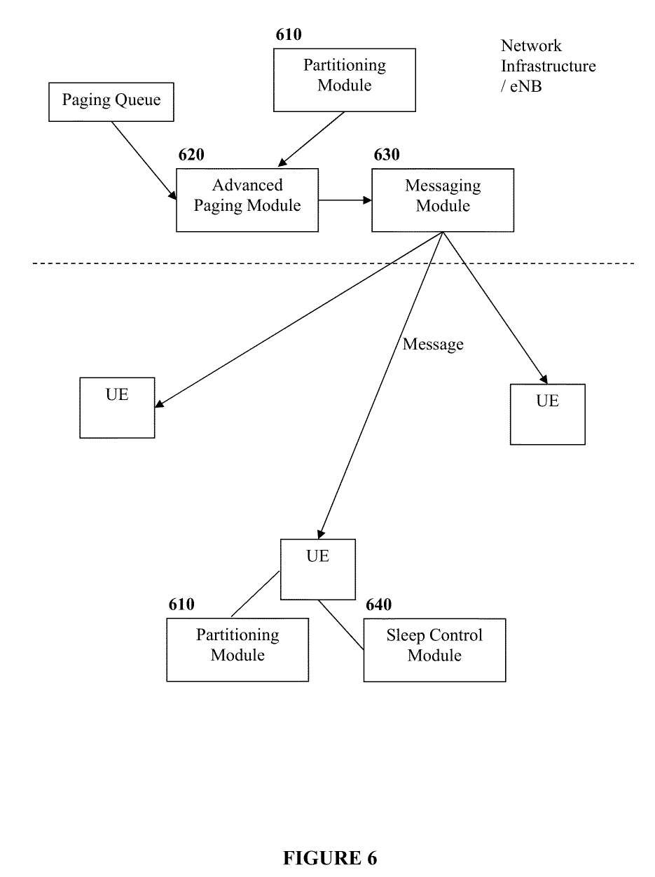

Various embodiments of the present invention may correspond to a system comprising a combination of LTE network infrastructure devices such as eNBs or related infrastructure equipment as well as LTE wireless terminal UEs such as MTC UEs or other UEs. The system may be described in terms of interacting modules, wherein each module corresponds to a selection of electronic components operating together to produce an effect. Such a system is illustrated for example in FIG. 6, and described below.

A partitioning module 610 may be provided which is configured to partition the plurality of UEs into a plurality of groups. The partitioning module may comprise components of the LTE network infrastructure devices, the eNB and the UEs. The network infrastructure devices and/or the eNB may assign UEs to groups based for example on their registered identities or other characteristics. This may be performed in advance or dynamically, for example by translating UE identities to group identities on an as-needed basis. In some embodiments, the eNB may send grouping messages to the UEs to inform each of the UEs which group it belongs to. In some embodiments, the UEs may be configured to determine which group it belongs to independently without such messaging, by running an identifier process which mirrors the partitioning process operating in the network infrastructure. The partitioning module may comprise a microprocessor which is configured to retrieve UE registered identities or other characteristics and process them for example via a lookup table operation or predetermined function to determine a group corresponding to the given UE identities and/or characteristics.

An advanced paging module 620 may be provided which is configured to determine the non-paging group which comprises one or more of the plurality of groups which include UEs that will not be paged in an upcoming paging occasion. The advanced paging module may operate within the network infrastructure and/or eNB and may be configured to access the queue of pending pages which will be transmitted in an upcoming Paging Occasion, and to obtain UE identifiers corresponding to pages pending in the queue. The advanced paging module is further configured to determine which groups are represented by these UE identifiers, for example via lookup table operation. The advanced paging module may again comprise a microprocessor operatively coupled to memory.

A messaging module 630 may be provided which is configured to transmit a message from the eNB to the plurality of UEs indicative of said non-paging group. The messaging module may be integrated with the eNB and may be configured to cause the eNB to wirelessly transmit the message in a manner as described elsewhere herein. The messaging module may comprise one or more of a microprocessor for controlling the eNB transmissions, baseband signal processing components of the eNB configured to prepare the message in a predetermined manner for transmission, or the like.

A sleep control module 640 of each of the plurality of UEs may be provided which is configured to cause UEs belonging to said non-paging group, to enter a sleep mode upon successful reception of the message. The sleep control module of each UE may comprise a microprocessor and/or signal processor or other electronics configured to influence sleep/wake operation of the UE by potentially transmitting a sleep signal which causes the UE to enter a low power mode for a predetermined amount of time.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of an associated computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

### EXAMPLE

### Simulation Results:

The following simulation results relate to the embodiments for transmitting QSI via PBCH including spreading the QSI message using orthogonal codes, spreading the QSI message using repetition only, and spreading the QSI message using repetition and forward error correction. A paging block represents QSI of 4 bits and a PBCH block is 480 bits (corresponding to 10 ms). Other system parameters were as follows:

Number of Tx Antennas=2

Number of Downlink RBs=6

PHICH duration=‘normal’

HICH Group Multiplier=1/6

SFN=randi([0 255])

Cell_Id=0

The SNR range considered was −10 dB to 0 dB.

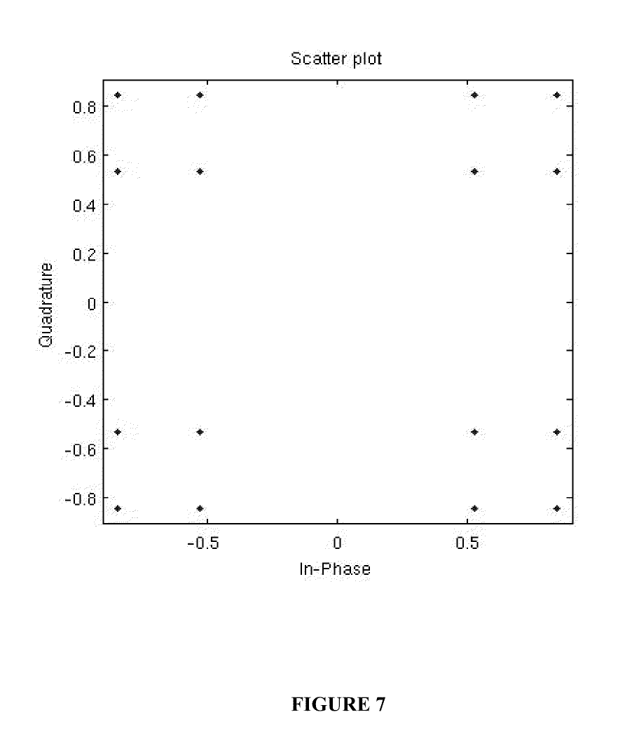

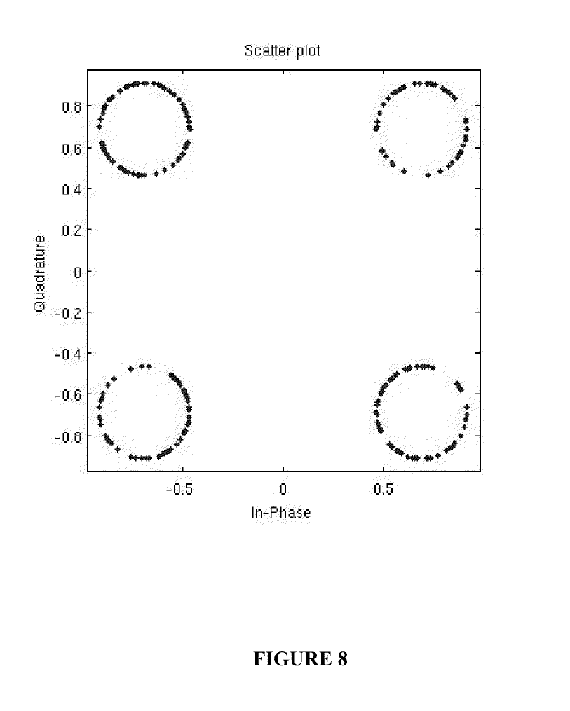

FIG. 7 and FIG. 8 depict the scatter plot for PBCH transmission along with QSI. FIG. 7 is for the case where QSI is spread using the spreading sequence [+1 +i −1 −i +1 +i −1 −i . . . ] with a total length of 240. FIG. 8 is for the case where the spreading sequence is exp(−i*2*pi*(0:239)/SPF).

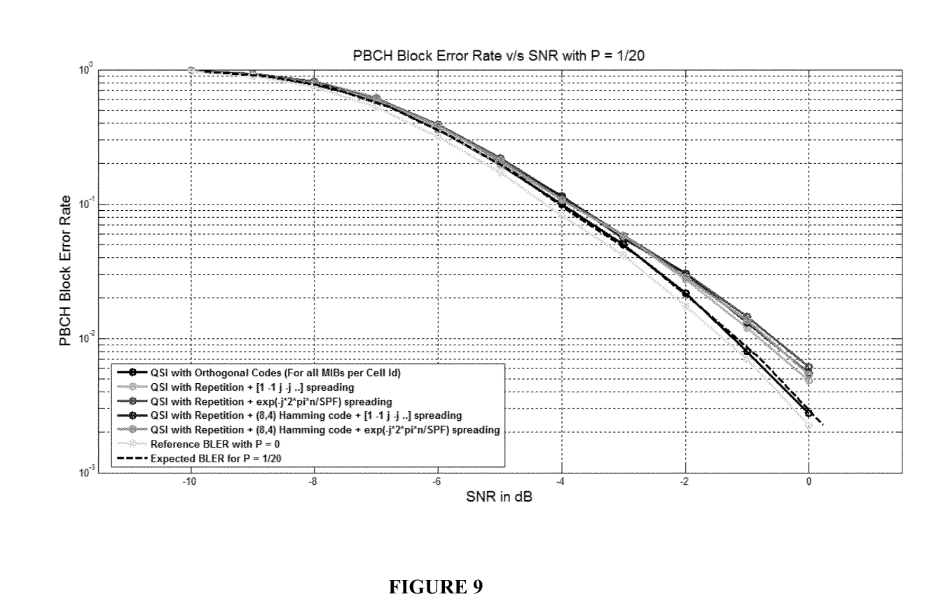

FIG. 9 depicts the PBCH block error rate (BLER). It also indicates the expected BLER curves when paging is introduced. The expected BLER curves are obtained with the assumption that paging signal reduces the PBCH SNR and should not affect PBCH detection. This aligns well the solution 1b. As expected, there is a difference between these expected BLER and actual BLER for solution 1c since the paging signal is not orthogonal to the PBCH signal and interferes with it.

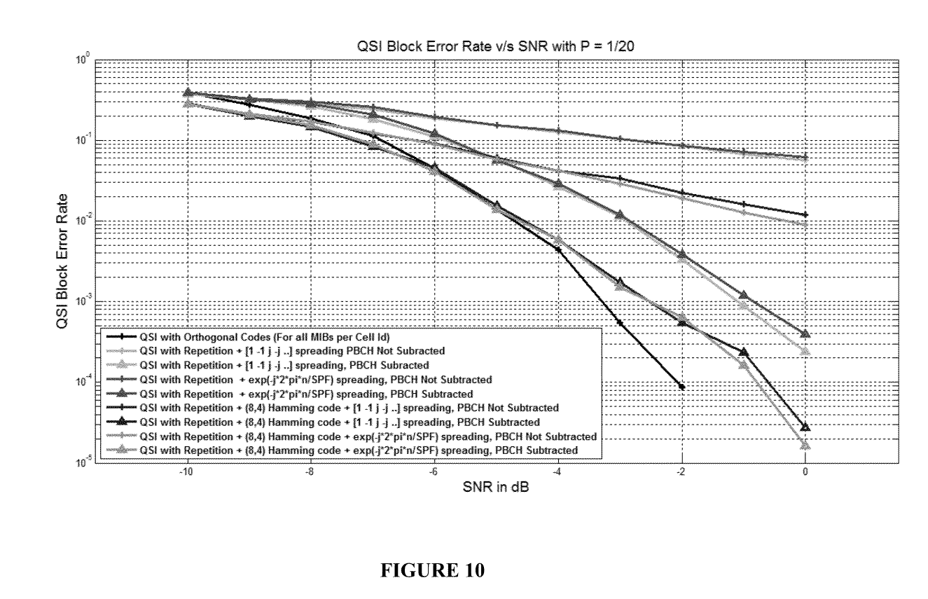

FIG. 10 indicates the QSI BLER for the different methods described. As expected, the performance of paging with orthogonal codes gives the best performance.

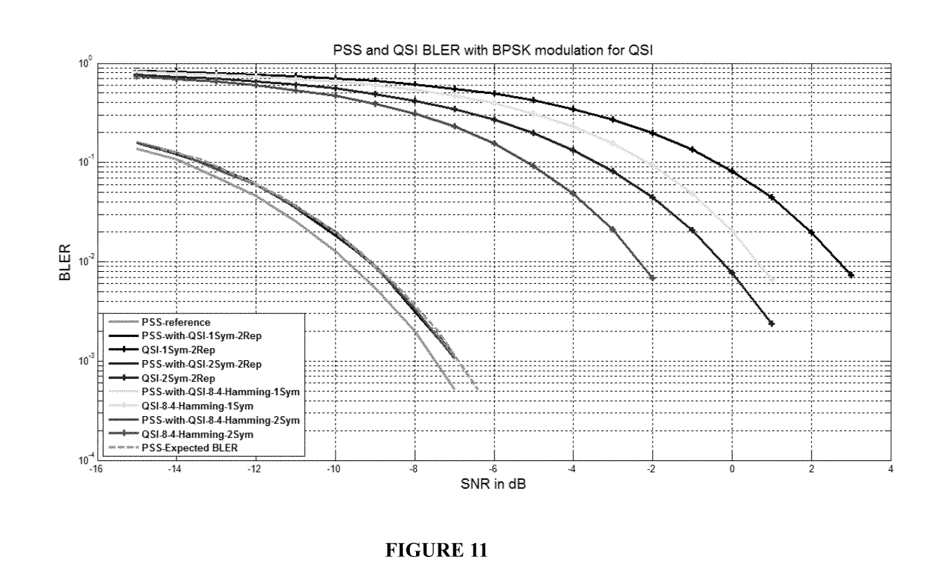

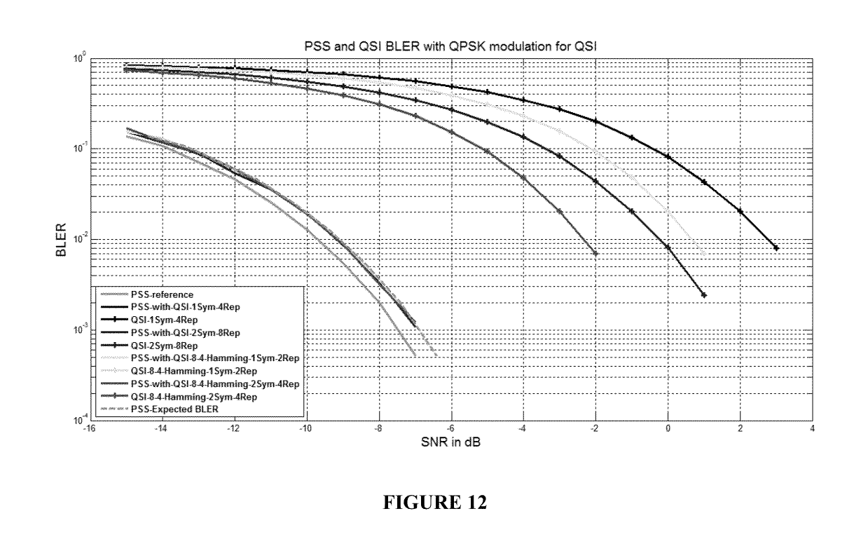

FIG. 11 and FIG. 12 depict the results for the methods 1 through 8 of Table I for the first one of the second set of embodiments, namely wherein paging on unused sub-carriers of the PSS is carried out. In particular, FIG. 11 depicts the results for methods 1 through 4 and FIG. 12 depicts the results for methods 5 through 8. These figures also contain the BLER for PBCH detection (without QSI) for comparison. It is can be seen that the performance of QSI for methods 4 and 8 is approximately 1 dB better than PBCH detection in a 10 ms frame only. Also, it should be noted that PBCH is over a 10 ms time-frame while PSS/SSS is over a 5 ms time-frame. Using the second PSS and SSS symbols may provide an additional gain of 3 dB (or more groups may be assigned).

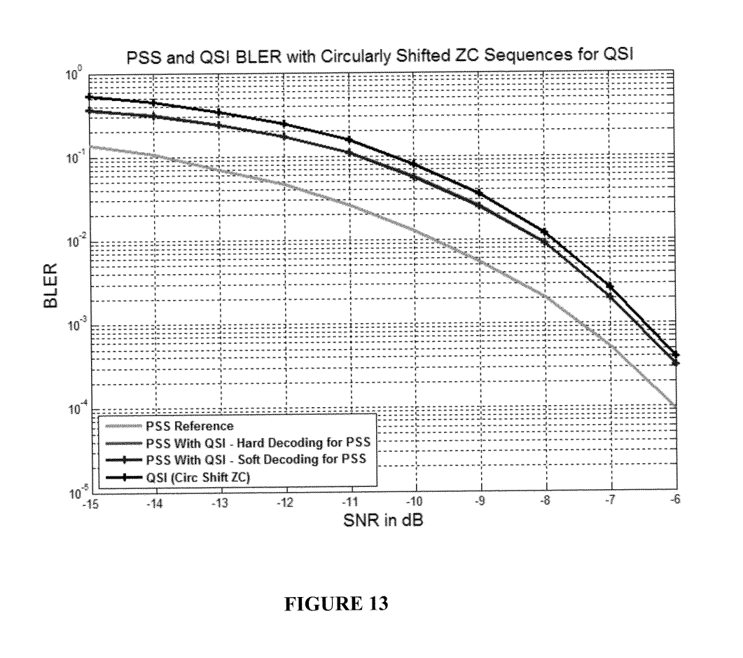

FIG. 13 illustrates the PSS and QSI BLER for the method of paging on the PSS using cyclically shifted Zadoff-Chu (ZC) sequences, as described above, considering 4 bits of QSI. It can be noted that there is approximately 1.6 dB degradation in PSS detection performance for 1% BLER. The degradation reduces to 0.9 dB for 0.1% BLER. The QSI BLER performance is very close to PSS BLER performance since paging also uses ZC sequences. Also, the results for soft decoding were similar to the hard decoding one.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for influencing operation of a plurality of UEs in an LTE wireless network, the method comprising:
a. partitioning the plurality of UEs into a plurality of groups;
b. determining a non-paging group, the non-paging group including one or more of the plurality of groups which include UEs that will not be paged in an upcoming paging occasion;
c. transmitting a message to the plurality of UEs indicative of said non-paging group;
wherein upon successful reception of the message UEs belonging to said non-paging group enter a sleep mode.

2. The method according to claim 1, wherein partitioning of the plurality of UEs is static.

3. The method according to claim 1, wherein transmitting the message occurs at a messaging frequency and wherein partitioning of the plurality of UEs is updated at a frequency relative to messaging frequency.

4. The method according to claim 1, wherein partitioning of the plurality of UEs is based on an identifier which is substantially unique for each UE.

5. The method according to claim 4, wherein the identifier is an international mobile subscriber identity (IMSI), UE ID or cell radio network temporary identifier (C-RNTI).

6. The method according to claim 1, wherein at least one of the plurality of groups includes UEs operating in a coverage enhancement (CE) mode.

7. The method according to claim 1, wherein plural messages are transmitted and each message is addressed to one of the plurality of groups.

8. The method according to claim 1, wherein the message is a broadcast message.

9. The method according to claim 1, wherein the message is transmitted using a physical broadcast channel (PBCH).

10. The method according to claim 1, wherein the message is transmitted using resources related to a primary synchronization signal (PSS) or secondary synchronization signal (SSS).

11. The method according to claim 1, wherein the message is transmitted using orthogonal codes.

12. The method according to claim 1, wherein the message is transmitted using repetition and forward error correction (FEC).

13. The method according to claim 1, wherein the message is transmitted as downlink control information (DCI) on a physical downlink control channel (PDCCH).

14. The method according to claim 13, wherein the DCI is positioned prior to a PSS.

15. A system comprising at least one eNB and a plurality of UEs communicatively coupled thereto, the eNB and the plurality of UEs belonging to an LTE wireless network, the system comprising:
a. a partitioning module configured to partition the plurality of UEs into a plurality of groups;
b. an advanced paging module configured to determine a non-paging group, the non-paging group including one or more of the plurality of groups which include UEs that will not be paged in an upcoming paging occasion;
c. a messaging module configured to transmit a message from the eNB to the plurality of UEs indicative of said non-paging group; and
d. a sleep control module operative on each of the plurality of UEs, the sleep control module configured to cause UEs belonging to said non-paging group, to enter a sleep mode upon successful reception of the message.

16. The system according to claim 15, wherein the partition module is configured to update partitioning of the plurality of UEs based on a messaging frequency, wherein the message is transmitted at the messaging frequency.

17. The system according to claim 15, wherein the partition module is configured to partition the plurality of UEs based on an identifier which is substantially unique for each UE.

18. The system according to claim 17, wherein the identifier is an international mobile subscriber identity (IMSI), UE ID or cell radio network temporary identifier (C-RNTI).

19. The system according to claim 15, wherein the messaging module is configured to transmit the message using a physical broadcast channel (PBCH) or resources related to primary synchronization signal (PSS) or secondary synchronization signal (SSS).

20. The system according to claim 15, wherein the messaging module is configured to transmit the message using orthogonal codes or a combination of repetition and forward error correction (FEC).

21. The method according to claim 15, wherein the messaging module is configured to transmit the message as downlink control information (DCI) on a physical downlink control channel (PDCCH).

22. The method according to claim 24, wherein the DCI is positioned prior to a primary synchronization signal (PSS).
